(19) United States
(12) Patent Application Publication
(10) Pub. No.: US 2010/0040403 A1
(43) Pub. Date: Feb. 18, 2010

(54) Ornamental articles and devices for attachment to writting instruments

(76) Inventor: Eric Mauro, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/583,023

(22) Filed: Aug. 12, 2009

Related U.S. Application Data
(60) Provisional application No. 61/188,644, filed on Aug. 12, 2008.

(51) Int. Cl. B43K 29/00

(52) U.S. Cl. 401/195

(57) ABSTRACT

Ornamental articles and devices such as, but not limited to, charms, flags, animated characters, flashlights, magnifying glasses, and gas pump speed pay devices clipped to or otherwise attached to a writing instrument, such as a pen. In a preferred embodiment, the ornamental articles and other devices clip to the top of the writing instrument. In a further embodiment, the ornamental articles and devices attach to the pocket clip of a writing instrument and are visibly displayed when the writing instrument is carried in a pocket of an article of clothing.

This application is based on provisional patent application Ser. No. 61/188,644 filed on Aug. 12, 2008.

### BACKGROUND OF THE INVENTION

1. Field of the Invention

The present invention relates to small ornamental articles and devices for carrying on one's person and, more particularly, to ornamental articles and devices for attachment to a writing instrument, such as a pen.

2. Discussion of the Related Art

Writing instruments, such as pens and pencils, are used on a daily basis by a majority of the public. And, while some writing instruments may be of an ornamental design, the primary function is to provide a means for writing notes, signing documents and preparing drawings or other written indicia. The function of a writing instrument can be enhanced by attaching an ornamental article or other device to the top of the writing instrument, such as a pocket clip. Such an ornamental article or other device can be readily displayed when attached in this manner without interfering with the normal use of the writing instrument. Moreover, when the writing instrument is carried in the pocket of an article of clothing, the ornamental article or other device can be displayed as a fashion accessory. And, in addition to providing a novelty fashion item of display, the attached ornamental article or other device may serve a further function. For example, a small flashlight, magnifying glass, screw driver, tweezer, or gas pump speed pass device are examples of functional devices that can be attached to a writing instrument for both ornamental purposes as well as functional purposes.

### SUMMARY OF THE INVENTION

The present invention is directed to ornamental articles and devices such as, but not limited to, charms, flags, animated characters, flashlights, magnifying glasses, and gas pump speed pay devices clipped to or otherwise attached to a writing instrument, such as a pen. In a preferred embodiment, the ornamental articles and other devices clip to the top of the writing instrument. In a further embodiment, the ornamental articles and devices attach to the pocket clip of a writing instrument and are visibly displayed when the writing instrument is carried in a pocket of an article of clothing.

### BRIEF DESCRIPTION OF THE DRAWINGS

For a fuller understanding of the nature of the present invention, reference should be made to the detailed description taken in conjunction with the accompanying drawings in which:

FIG. 1 is a perspective view of a pen showing one embodiment of the ornamental articles and devices attached to the pocket clip of the pen and including a flag and a charm;

FIG. 2 is a top plan view showing a further embodiment of the ornamental articles and devices for attachment to a writing instrument, in accordance with the present invention;

FIG. 3 is top plan view showing yet a further embodiment of the ornamental articles and devices for attachment to a writing instrument; and

FIG. 4 is yet a further embodiment of the ornamental articles and devices of the present invention for attachment to a writing instrument.

Like reference numerals refer to like parts throughout the several views of the drawings.

### DETAILED DESCRIPTION OF THE PREFERRED EMBODIMENTS

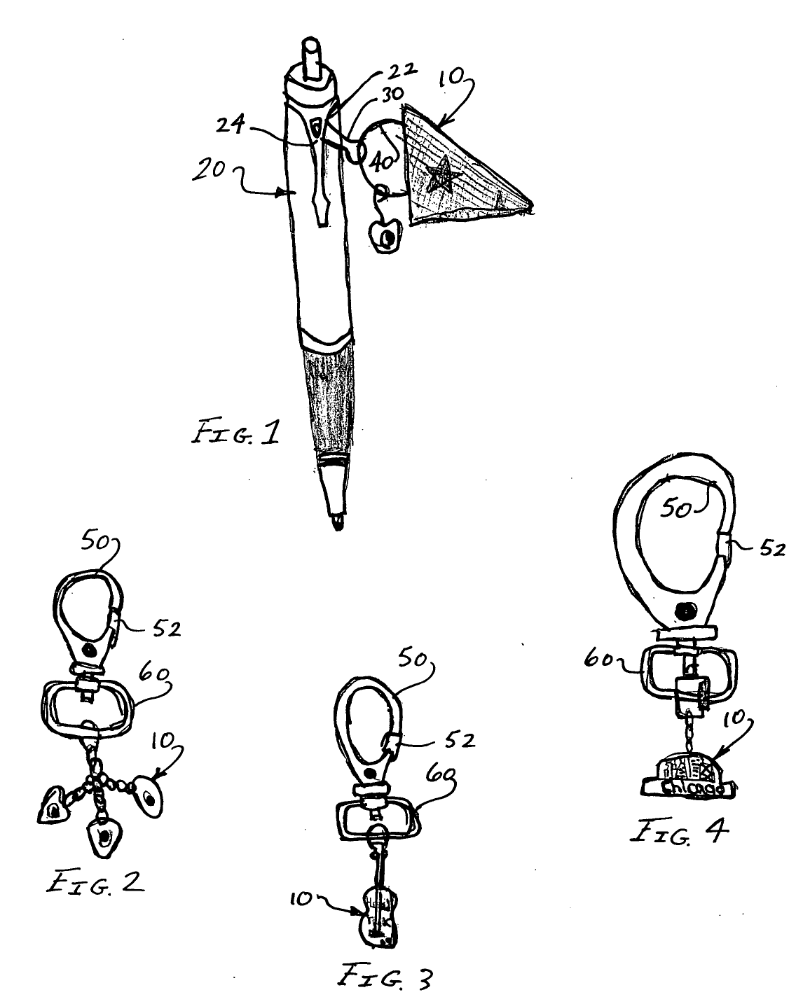

Referring to the several views of the drawings, and initially FIG. 1, the ornamental articles and devices representing the present invention are shown and are generally indicated a 10 throughout the drawing figures.

As seen in FIG. 1, the ornamental article 10 is intended to be attached to a writing instrument, such as a pen 20. The article 10 includes a clip 30 or other attachment device which is structured and disposed for attachment to the top 22 of the pen 20. In the embodiment shown in FIG. 1, a clip 30 attaches to the pocket clip 24 of the pen 20. From the attachment clip 30, a ring 40 is loosely supported and provides a means for carrying the one or more ornamental articles 10 and devices such as, but not limited to, the flag and charm shown in FIG. 1 which hang loosely from the top end of the writing instrument. It should be noted that virtually any other ornamental article or functional device could be carried on the ring 40 such as, but not limited to, a small flashlight, tool, gas speed pump pass, magnifying glass, animated character and the like.

Referring to FIG. 2, a further embodiment of the attachment device of the invention is shown. The attachment device includes a clasp 50 with a spring loaded closure mechanism 52 for attaching the ornamental article 10 to the pocket clip 24 or other structure on the top 22 of a writing instrument 20. A ring 60 fitted to the clasp carries one or more ornamental articles 10 or functional devices, such as a plurality of charms hanging from a linked chain arrangement or other structure.

FIG. 3 shows yet a further embodiment of the invention wherein the ring 60 on the clasp device 50 carries a miniature guitar representing the ornamental article 10.

FIG. 4 shows yet a further embodiment of the invention wherein the clasp 50 includes the ring 60 for carrying an ornamental article 10 such as a plate or other device with ornamental indicial thereon, such as the name of a city or other geographical location with an ornamental background.

It should be noted that the various ornamental articles and devices shown in the drawings are for purposes of example only. It is contemplated that a wide variety of ornamental articles and functional devices not shown in the drawings are to be used as part of the invention.

While the present invention has been shown and described in accordance with preferred and practical embodiments thereof, it is recognized that departures from the instant disclosure are contemplated within the spirit and scope of the invention.

What is claimed is:

1. A device comprising:
a writing instrument including a top end portion;
a closed ring;
at least one article held on said ring and hanging therefrom;
a releasable attachment member connected to said ring and being structured and disposed for removable attachment to said top end portion of said writing instrument so that said ring and said at least one article hang loosely from said writing instrument.

2. The device as recited in claim 1 wherein said top end portion of said writing instrument includes a pocket clip and said releasable attachment member is structured and disposed for removable attachment to said pocket clip.

3. The device as recited in claim 2 wherein said releasable attachment member is a clip.

4. The device as recited in claim 2 wherein said releasable attachment member is a clasp with a spring loaded closure.

5. The device as recited in claim 2 wherein said at least one article is an ornamental charm.

6. The device as recited in claim 2 wherein said at least one article is a functional device.

7. The device as recited in claim 2 further comprising;
a plurality of said articles held on said ring and hanging loosely therefrom.
